(19) United States
(12) Patent Application Publication
(10) Pub. No.: US 2018/0364340 A1
(43) Pub. Date: Dec. 20, 2018

(54) DISTANCE MEASURING APPARATUS

(71) Applicant: Hoshibumi Ichiyanagi, Aichi (JP)

(72) Inventor: Hoshibumi Ichiyanagi, Aichi (JP)

(73) Assignee: OMRON AUTOMOTIVE ELECTRONICS CO., LTD., Aichi (JP)

(21) Appl. No.: 16/008,907

(22) Filed: Jun. 14, 2018

(30) Foreign Application Priority Data
Jun. 14, 2017 (JP) 2017-116633

(51) Int. Cl. G01S 7/487; G01S 7/486

(52) U.S. Cl. CPC G01S 7/4873; G01S 7/4861; G01S 7/4865

(57) ABSTRACT

A distance measuring apparatus includes: a light emitter emitting a light pulse, a light receiver receiving reflected light of the light pulse by an object, a comparator that compares an output signal from the light receiver to a threshold and outputs a predetermined signal when the output signal is larger than the threshold, and a distance calculator that detects a reception time of the reflected light when the comparator outputs the predetermined signal and calculates a distance to the object based on the reception time and an irradiation time of the light pulse. The distance measuring apparatus further includes a maximum value detector that detects a maximum value of the output signal from the light receiver during a non-light receiving period, and a threshold setting unit that sets the threshold in the non-light receiving period based on the maximum value.

### CROSS-REFERENCE TO RELATED APPLICATION

This application is based on Japanese Patent Application No. 2017-116633 filed with the Japan Patent Office on Jun. 14, 2017, the entire contents of which are incorporated herein by reference.

### FIELD

The disclosure relates to a distance measuring apparatus that measures a distance to an object based on time a light pulse is emitted from a light emitter and time reflected light of the light pulse is received from the object by a light receiver.

### BACKGROUND

For example, an optical distance measuring apparatus such as a laser radar is mounted on a vehicle having a collision prevention function. In the distance measuring apparatus, a light pulse is emitted from a light emitting element of a light emitter, reflected light of the light pulse by an object is received by a light receiving element of a light receiver, and a distance to the object is measured based on an irradiation time of the light pulse and a reception time of the reflected light.

Specifically, for example, as disclosed in Japanese Unexamined Patent Application Publication Nos. 2010-91378 (Patent Literature 1), 2014-81254 (Patent Literature 2), and 2014-81253 (Patent Literature 3), Japanese Translation of PCT International Application Publication No. 2012-530917 (Patent Literature 4), and Japanese Unexamined Patent Application Publication Nos. 2016-151458 (Patent Literature 5) and 2016-161438 (Patent Literature 6), a flight time since the object is irradiated with the light pulse until the light pulse is reflected by the object and returned is measured by a Time of Flight (TOF) method, and the distance to the object is calculated based on the flight time. There is also an image acquiring apparatus that acquires an image of the object by the TOF method.

In the distance measuring apparatus based on the TOF method, a plurality of Avalanche Photo Diodes (APDs) in a Geiger mode arranged in an array are frequently used in the light receiver. The Geiger mode APD is a photo count type light receiving element that outputs one voltage pulse for incidence of one photon. The Geiger mode APD is also called a Single Photon Avalanche Diode (SPAD) because the Geiger mode APD causes an avalanche phenomenon even when a single photon is incident.

Consequently, for example, a voltage pulse generated by the Geiger mode APD and an arrival time of the voltage pulse are repeatedly measured to produce a histogram, and the TOF (the flight time of the pulse light) is detected based on a maximum value of the histogram. For example, a Time to Digital Converter (TDC) is used to measure the arrival time of the voltage pulse and the TOE (See Patent Literatures 1 to 6) The photo-count type light receiving element is also used, for example, in a light amount detecting device for semiconductor inspection. (See Japanese Unexamined Patent Application Publication No. 2012-37267 (Patent Literature 7))

Techniques for enhancing detection accuracy of a physical quantity such as a distance, an image, and a light quantity are disclosed in Patent Literatures 1 to 7.

For example, in Patent Literatures 1 to 6, a voltage signal generated by the Geiger mode APD and the arrival time of the voltage signal are repeatedly measured to produce a histogram, and the TOF is detected based on the maximum value of the histogram. Then, the distance to the object is calculated based on the TOE

In Patent Literature 1, intensity of the light received from the object by a peripheral circuit of the APD during a pause period of the light pulse emitted from the light emitter is obtained, thereby obtaining the image of the object independent of the distance to the object.

In Patent Literature 2, the light from a region to be measured next time by measuring light receiving unit (Geiger mode APD) is received by reference light receiving unit, and sensitivity of the measuring light receiving unit is controlled according to the received light amount. The voltage pulse output from the measuring light receiving unit is shaped by a pulse shaping circuit and added, and a determination result indicating the arrival of the reflected pulse is output to the TDC when the added value is equal to or larger than a predetermined threshold. The threshold is changed according to a signal indicating the intensity of ambient light output from the reference light receiving unit.

In Patent Literature 3, voltage pulses output from all the Geiger mode APDs are converted into current pulses by voltage-current converting unit, the current pulses are added, and time integration is performed by integrating unit, whereby the time-integrated value is output as the light quantity.

In Patent Literature 4, a detection probability of the photon is controlled by changing a reverse bias voltage of the SPAD based on a comparison result between the number of detection pulses of the SPAD and a certain threshold.

In Patent Literatures 5 and 6, a histogram is produced with a vertical axis representing a count value which is the number (the number of pixels) of SPADs that receive the reflected light by the object and a horizontal axis representing time. In Patent Literature 5, when an absolute value of the larger one of a difference between the maximum value of the histogram and an initial value and a difference between the minimum value and the initial value is equal to or larger than a calculation determination value, the distance to the object is calculated based on the time corresponding to the absolute value. A change amount from the initial value of a portion except for the maximum value or the minimum value of the histogram is recognized as the ambient light, and the calculation determination value is varied based on the change amount.

In Patent Literature 6, when a sum, an average value, or a median value of the histogram exceeds a first threshold, the data in the integration direction of the count value is compressed, and the distance to the object is calculated based on the maximum value of the compressed histogram. The first threshold is set based on an ambient light quantity value of the previous measurement and an SN ratio (signal-noise ratio).

In Patent Literature 7, in order to remove a noise, the detection signal of the SPAD is subjected to A/D conversion (analog-digital conversion), the converted detection signal is sent to a photon number calculation circuit when the converted detection signal is equal to or larger than a threshold, and a reference value set in advance is sent to the photon number calculation circuit when the converted detection signal is less than the threshold. The photon number calculation circuit obtains the number of photons or the light quantity incident on the SPAD from an area of a waveform of the detection signal acquired until completion of the light amount measurement. The detection signal of the SPAD during no emission is acquired as a noise signal, and the threshold and the reference value are set based on the average value, the variation, or the maximum value of the noise signal.

In the distance measuring apparatus that measures the distance to the object, the light received by the light receiver includes not only the reflected light by the object of the light pulse emitted from the light emitter but also the ambient light. In addition, the signal output from the light receiver includes not only a light receiving signal based on the reflected light but also the noise caused by the ambient light or an ambient temperature. Conventionally, because the light receiving signal based on the reflected light is larger than the noise in fluctuation, the maximum value of the output signal from the light receiver is extracted by comparing the output signal from the light receiver to the threshold, and the time since the irradiation of the light pulse until the reception of the reflected light by the object is measured based on the maximum value. However, the distance to the object cannot accurately be calculated when the maximum value of the output signal from the light receiver or the time since the irradiation of the light pulse until the reception of the reflected light cannot accurately be detected.

### SUMMARY

An object of the disclosure is to provide a distance measuring apparatus capable of accurately measuring the distance to the object even if the noise is included in the signal output from the light receiver.

According to an aspect of one or more embodiments of the disclosure, a distance measuring apparatus includes: a light emitter including a light emitting element that emits a light pulse; a light receiver including a plurality of light receiving elements that receive reflected light of the light pulse by an object; a comparison output unit that compares an output signal output from the light receiver according to a reception state of the light receiving element to a predetermined threshold and outputs a predetermined signal when the output signal is larger than the threshold; a distance calculator that detects a reception time of the reflected light by the light receiver when the comparison output unit outputs the predetermined signal, and calculates a distance to the object based on the reception time and an irradiation time of the light pulse from the light emitter; a maximum value detector that detects a maximum value of the output signal from the light receiver during a non-light receiving period in which the light receiver does not receive the reflected light; and a threshold setting unit that sets the threshold in the non-light receiving period based on the maximum value detected by the maximum value detector.

Because the light receiver receives the ambient light during a period in which the light receiver does not receive the reflected light by the object of the light pulse emitted from the light emitter, the output signal output from the light receiver according to the reception state becomes only the noise based on ambient light and the ambient temperature. Consequently, the maximum value of the noise is detected, and the threshold is set based on the maximum value, whereby the threshold can be set according to the noise level. Even if the noise is included in the output signal output from the light receiver in the period in which the light receiver receives the reflected light, the light receiving signal based on the reflected light and the noise can certainly be distinguished by comparing the output signal to the threshold. When the output signal output from the light receiver is larger than the threshold, namely, when the output signal output from the light receiver is the light receiving signal based on the reflected light, because the comparison output unit outputs the predetermined signal, the distance calculator detects the reception time of the reflected light, and the distance to the object can accurately be calculated based on the reception time and the irradiation time of the light pulse. Thus, the distance to the object can accurately be measured even if the noise is included in the signal output from the light receiver.

In one or more embodiments of the disclosure, the threshold setting unit may set the threshold to a value equal to or greater than the maximum value detected by the maximum value detector.

In one or more embodiments of the disclosure, the light receiving element may be constructed with an Avalanche Photo Diode (APD) in a Geiger mode, and the light receiver may include at least one light receiving element group in which the plurality of light receiving elements are connected in parallel, and output a voltage signal corresponding to a current output from the light receiving element group as the output signal.

In one or more embodiments of the disclosure, during the non-light receiving period, the comparison output unit may sequentially switch a plurality of tentative thresholds having stepwise different sizes, compare the plurality of tentative thresholds to the output signal output from the light receiver, and output the predetermined signal when the output signal is larger than the tentative threshold, and the maximum value detector may detect the maximum value of the output signal output from the light receiver based on an output frequency of the predetermined signal output from the comparison output unit in each tentative threshold.

In one or more embodiments of the disclosure, the distance measuring apparatus may further include a 1-bit analog-to-digital converter that converts the analog predetermined signal output from the comparison output unit into a digital predetermined signal and outputs the digital predetermined signal to the distance calculator.

In one or more embodiments of the disclosure, the distance calculator may include a Time to Digital Converter (TDC).

The disclosure can provide a distance measuring apparatus capable of accurately measuring the distance to the object even if the noise is included in the signal output from the light receiver.

### BRIEF DESCRIPTION OF THE DRAWINGS

FIG. 1 is a view illustrating a state of an optical system of a distance measuring apparatus according to one or more embodiments of the disclosure when the optical system is viewed from above;

FIG. 2 is a view illustrating a state of the optical system of the distance measuring apparatus in FIG. 1 when the optical system is viewed from a rear;

FIG. 3 is a view illustrating a light receiving surface of an SPAD array in FIG. 1;

FIG. 4 is a view illustrating an electrical configuration of the distance measuring apparatus in FIG. 1;

FIG. 5 is a view illustrating an output signal of a light receiving module in FIG. 3;

FIGS. 6A and 6B are views illustrating operation timing of the distance measuring apparatus in FIG. 1;

FIGS. 7A to 7D are views illustrating output signals of the light receiving module and a comparator in FIG. 3 during noise detection;

FIGS. 8A and 8B are views illustrating output signals of the light receiving module and the comparator in FIG. 3 during detection of reflected light;

FIG. 9 is a view illustrating an electrical configuration of a distance measuring apparatus according to one or more embodiments of the disclosure;

FIG. 10 is a view illustrating a circuit configuration of a TDC in FIG. 9; and

FIG. 11 is a view illustrating an electrical configuration of a distance measuring apparatus according to one or more embodiments of the disclosure.

### DETAILED DESCRIPTION

Hereinafter, embodiments of the disclosure will be described with reference to the drawings. In the drawings, the identical or equivalent component is designated by the identical numeral. In embodiments of the disclosure, numerous specific details are set forth in order to provide a more through understanding of the invention. However, it will be apparent to one of ordinary skill in the art that the invention may be practiced without these specific details. In other instances, well-known features have not been described in detail to avoid obscuring the invention.

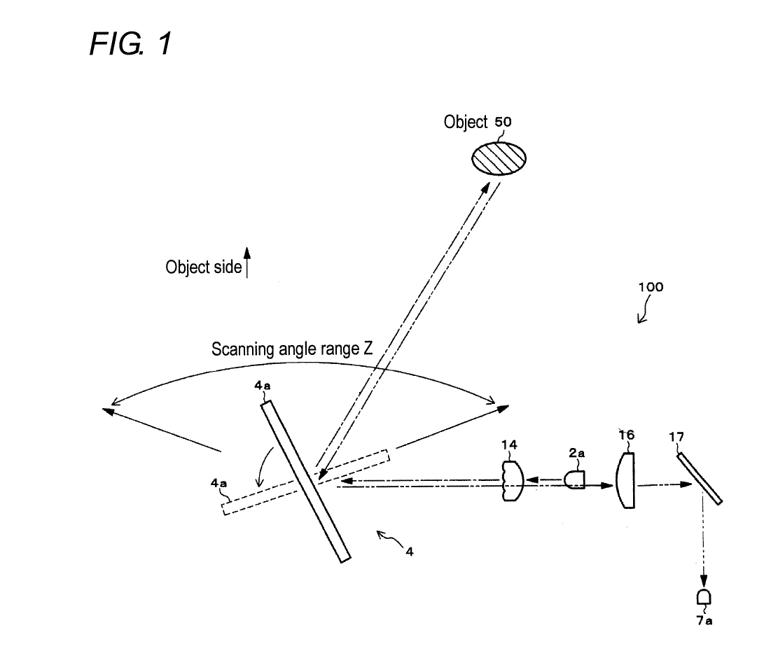

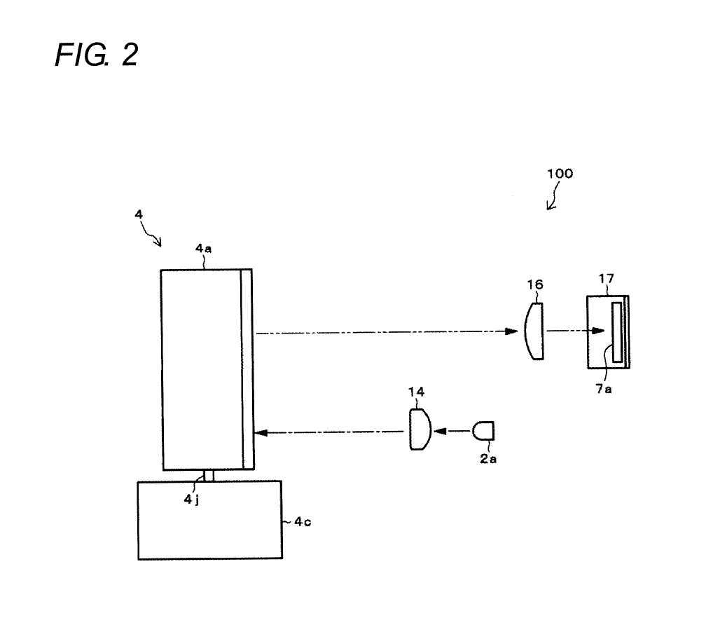

FIG. 1 is a view illustrating a state in which an optical system of a distance measuring apparatus 100 is viewed from above. FIG. 2 is a view illustrating a state of the optical system of the distance measuring apparatus 100 when the optical system is viewed from a rear (a lower side in FIG. 1, namely, an opposite side to an object 50).

The distance measuring apparatus 100 is an on-vehicle laser radar. The optical system of the distance measuring apparatus 100 is constructed with a Laser Diode (LD) 2a, a light projecting lens 14, a rotation scanning unit 4, a light receiving lens 16, a reflection mirror 17, and a Single Photon Avalanche Diode (SPAD) array 7a. The LD 2a, the light projecting lens 14, and the rotation scanning unit 4 are a light projecting optical system. The rotation scanning unit 4, the light receiving lens 16, the reflection mirror 17, and the SPAD array 7a are a light receiving optical system.

These optical systems are accommodated in a case (not illustrated) of the distance measuring apparatus 100. A front surface (the side of the object 50) of the case is opened, but it is covered with a translucent cover. The distance measuring apparatus 100 is installed in a front portion, a rear portion, or left and right sides of a vehicle such that the translucent cover faces the front, the back, or the left and right sides of the vehicle.

The LD 2a is a light emitting element that emits a high-power light pulse. In FIGS. 1 and 2, only one LD 2a is illustrated for convenience. However, a plurality of LDs 2a are actually arranged in a vertical direction in FIG. 2. The LD 2a is arranged such that a light emitting surface of the LD 2a faces the side of the rotation scanning unit 4.

A plurality of SPADs are arrayed in the SPAD array 7a. The SPAD is an Avalanche Photo Diode (APD) in the Geiger mode, and is a photo count type light receiving element. The SPAD array 7a is arranged such that the light receiving surface of the SPAD array 7a faces the side of the reflection mirror 17.

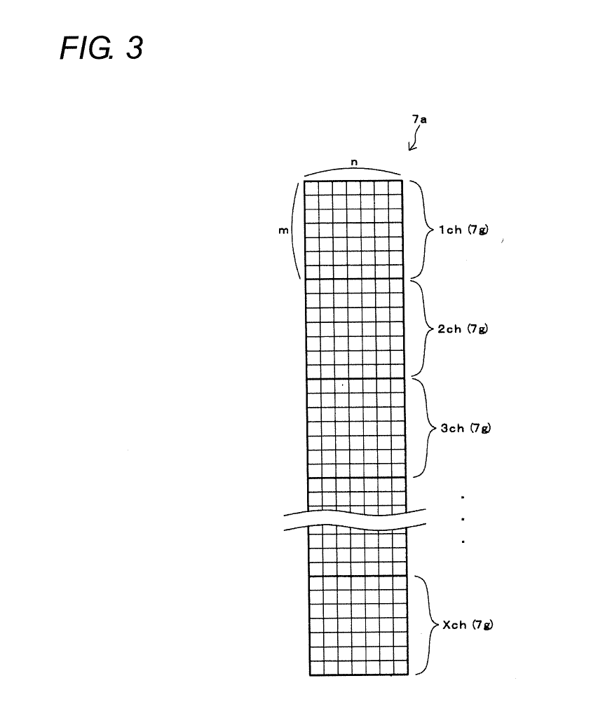

FIG. 3 is a view illustrating the light receiving surface of the SPAD array 7a. The light receiving surface of the SPAD array 7a is divided into a plurality of channels 1ch to Xch in a longitudinal direction (the vertical direction in FIG. 2). Each of the channels 1ch to Xch is divided into m pixels in the longitudinal direction and n pixels in the crosswise direction, namely, a total of m×n pixels. The SPAD is provided in each pixel on the light receiving surface in a one-to-one correspondence. That is, the number of SPADs in the SPAD array 7a is the same as the number of pixels on which photons are incident.

The rotation scanning unit 4 in FIGS. 1 and 2 is also called a rotating mirror or an optical deflector. The rotation scanning unit 4 includes a rotating mirror 4a and a motor 4c. The rotating mirror 4a is formed into a plate shape. A front surface and a rear surface of the rotating mirror 4a constitute a reflection surface.

As illustrated in FIG. 2, the motor 4c is provided below the rotating mirror 4a. A rotation shaft 4j of the motor 4c is parallel to the vertical direction. A connecting shaft (not illustrated) located in a center of the rotating mirror 4a is fixed to an upper end of the rotating shaft 4j of the motor 4c. The rotating mirror 4a rotates in conjunction with the rotation shaft 4j of the motor 4c.

As illustrated in FIG. 2, the light receiving lens 16, the reflection mirror 17, and the SPAD array 7a are disposed around an upper portion of the rotating mirror 4a. The LD 2a and the light projecting lens 14 are disposed around a lower portion of the rotating mirror 4a.

As indicated by an alternate long and short dash line arrow in FIGS. 1 and 2, after spread of a light pulse emitted from the LD 2a is adjusted by the light projecting lens 14, the light pulse strikes on a lower half region of the front or rear surface of the rotating mirror 4a. At this point, the motor 4c rotates to change an angle (direction) of the rotating mirror 4a, and the front or rear surface of the rotating mirror 4a is set at a predetermined angle that faces the side of the object 50 (for example, the state of the rotating mirror 4a indicated by a solid line in FIG. 1). Consequently, the light pulse emitted from the LD 2a is reflected by the lower half region of the front or rear surface of the rotating mirror 4a after passing through the light projecting lens 14, and a predetermined range located outside the distance measuring apparatus 100 is scanned with the light pulse. That is, in the rotation scanning unit 4, the light pulse from the LD 2a is reflected by the front or rear surface of the rotating mirror 4a, and deflected toward the side of the object 50.

A scanning angle range Z illustrated in FIG. 1 is a predetermined range (in planar view), in which the light pulse from the LD 2a is reflected by the front or rear surface of the rotating mirror 4a of the rotation scanning unit 4 and projected from the distance measuring apparatus 100. That is, the scanning angle range Z is a detection range of the object 50 using the distance measuring apparatus 100.

As described above, the light pulse projected from the distance measuring apparatus 100 is reflected by the object 50 such as a person or an object. The reflected light strikes on the upper half region of the front or rear surface of the rotating mirror 4a as indicated by an alternate long and two short dashes line arrow in FIGS. 1 and 2. At this point, the motor 4c rotates to change an angle (direction) of the rotating mirror 4a, and the front or rear surface of the rotating mirror 4a is set at a predetermined angle that faces the side of the object 50 (for example, the state of the rotating mirror 4a indicated by a solid line in FIG. 1). Consequently, the reflected light from the object 50 is reflected by the upper half region of the front or rear surface of the rotating mirror 4a, and is incident on the light receiving lens 16. That is, in the rotation scanning unit 4, the light reflected from the object 50 is reflected by the front or rear surface of the rotating mirror 4a, and deflected toward the side of the light receiving lens 16.

The reflected light incident on the light receiving lens 16 through the rotation scanning unit 4 is collected by the light receiving lens 16, reflected by the reflection mirror 17, and received by the SPAD array 7a. That is, in the rotation scanning unit 4, the reflected light from the object 50 is reflected by the rotating mirror 4a, and guided to the SPAD array 7a through the light receiving lens 16 and the reflection mirror 17.

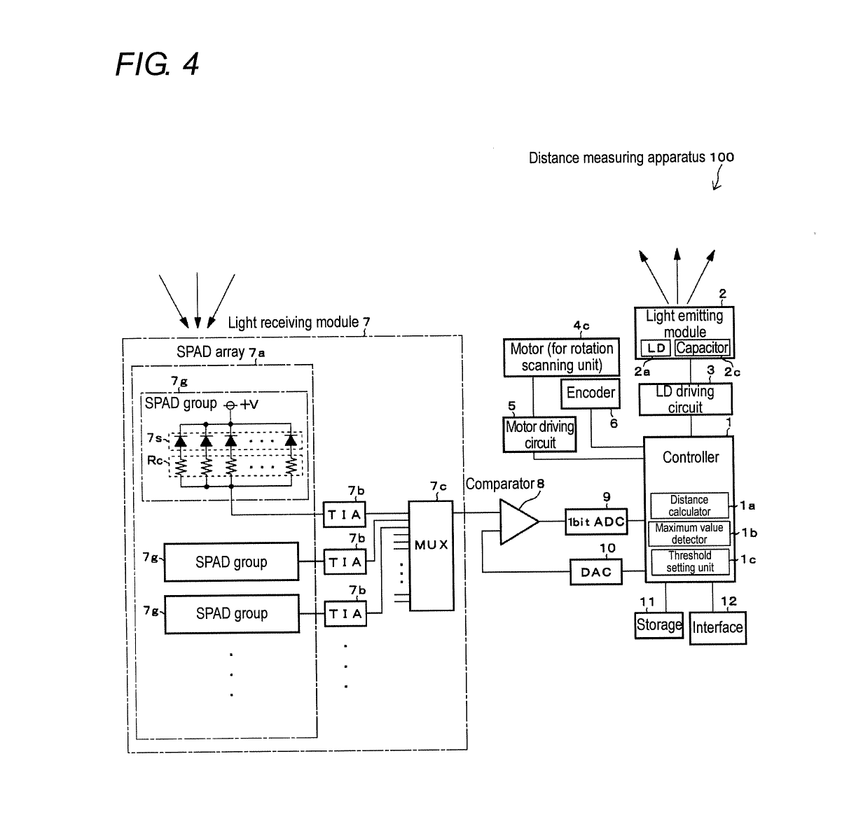

FIG. 4 is an electrical configuration diagram of the distance measuring apparatus 100. The distance measuring apparatus 100 includes a controller 1, a light emitting module 2, an LD driving circuit 3, the motor 4c, a motor driving circuit 5, an encoder 6, a light receiving module 7, a comparator 8, an Analog to Digital Converter (ADC) 9, a Digital to Analog Converter (DAC) 10, a storage 11, and an interface 12.

The controller 1 is constructed with a microcomputer, and controls operation of each unit of the distance measuring apparatus 100. The controller 1 includes a distance calculator 1a, a maximum value detector 1b, and a threshold setting unit 1c.

The storage 11 is constructed with a volatile or nonvolatile memory. For example, information used to control each unit of the distance measuring apparatus 100 by the controller 1 or information used to measure the distance to the object 50 is stored in the storage 11.

The interface 12 is constructed with a communication circuit that communicates with an electronic controller (ECU) mounted on the vehicle. The controller 1 transmits and receives information about the distance to the object 50 and various pieces of control information to and from the ECU through the interface 12.

The plurality of the LDs 2a and a capacitor 2c that is used to cause each LD 2a to emit the light are provided in the light emitting module 2. For convenience, each one block of the LD 2a and the capacitor 2c is illustrated in FIG. 4. The light emitting module 2 is an example of the “light emitter” in one or more embodiments of the disclosure.

The controller 1 controls the operation of the LD 2a of the light emitting module 2 using the LD driving circuit 3. Specifically, the controller 1 causes the LD 2a to emit the light using the LD driving circuit 3, and irradiates the object 50 such as a person or an object with the light. The controller 1 stops the light emission of the LD 2a using the LD driving circuit 3, and charges the capacitor 2c.

The controller 1 controls the driving of the motor 4c of the rotation scanning unit 4 using the motor driving circuit 5. As described above, the controller 1 rotates the rotating mirror 4a to deflect the light pulse emitted from the LD 2a and the light reflected from the object 50. At this point, based on the output of the encoder 6, the controller 1 detects a rotation state (such as a rotation angle and a rotation speed) of the motor 4c or the rotating mirror 4a.

The light receiving module 7 includes the SPAD array 7a, a Trans Impedance Amplifier (TIA) 7b, and a multiplexer (MUX) 7c. The light receiving module 7 is an example of the “light receiver” in one or more embodiments of the disclosure.

The SPAD array 7a includes a plurality of SPAD groups 7g. In FIG. 4, the circuit configuration of the SPAD group 7g located at the uppermost position is representatively illustrated, but the other SPAD groups 7g have the similar circuit configuration.

In each SPAD group 7g, one pixel (basic unit) is formed by connecting one end of a quenching resistor Rc to an anode of the SPAD 7s, and a large number of pixels are connected in parallel. Each SPAD group 7g corresponds to each of the channels 1ch to Xch in FIG. 3. Consequently, in each SPAD group 7g, the SPAD 7s and the quenching resistor Rc are provided for m×n pixels. The SPAD array 7a (or the SPAD group 7g) is also called a Multi-Pixel Photon Counter (MPPC).

The other end of each quenching resistor Rc of each SPAD group 7g is connected to the TIA 7b. A cathode of the SPAD 7s of each SPAD group 7g is connected to a power supply +V. Sometimes a low pass filter is provided between each SPAD group 7g and the power supply +V.

The TIA 7b is provided for each SPAD group 7g. In FIG. 4, for convenience, only the TIA 7b connected to a part of the SPAD group 7g is illustrated, but the TIAs 7b are similarly connected to the other SPAD groups 7g.

When a single photon enters at least one SPAD 7s by applying a bias voltage equal to or higher than a breakdown voltage to each SPAD 7s in each SPAD group 7g, the SPAD 7s performs Geiger discharge to output a predetermined current (avalanche phenomenon). At this point, output currents from the SPADs 7s connected in parallel are added, and the added current flows through the SPAD group 7g.

When the SPAD 7s outputs the current, the voltage at both ends of the quenching resistor Rc connected to the SPAD 7s rises and the bias voltage of the SPAD 7s drops. When the bias voltage drops below the breakdown voltage, the Geiger discharge of the SPAD 7s is stopped, the current is not output from the SPAD 7s, the voltage at both ends of the quenching resistor Rc drops, and a voltage equal to or higher than the breakdown voltage is applied to the SPAD 7s again. Consequently, the added current of each SPAD 7s does not flow through the SPAD group 7g, and the next photon can be detected by the SPAD 7s.

The output current from the SPAD group 7g as described above is converted into a voltage signal by the TIA 7b connected to the SPAD group 7g, and output to the MUX 7c. The MUX 7c selects the output signal of each TIA 7b, and outputs the selected output signal to the comparator 8. That is, the voltage signal corresponding to the light receiving state of the SPAD 7s of each SPAD group 7g is sequentially output from the light receiving module 7 to the comparator 8.

Depending on the irradiation angle of the light pulse emitted from the LD 2a of the light emitting module 2, the reflected light of the light pulse by the object 50 is incident on the corresponding channels 1ch to Xch on the light receiving surface of the SPAD array 7a illustrated in FIG. 3. Ambient light such as sunlight also enters each of the channels 1ch to Xch.

That is, the photon of the light reflected by the object 50 or the photon of the ambient light is incident on each SPAD 7s of each SPAD group 7g. For this reason, the voltage signal is output from each SPAD group 7g based on the reception of the photon of the light reflected by the object 50 or the reception of the photon of the ambient light.

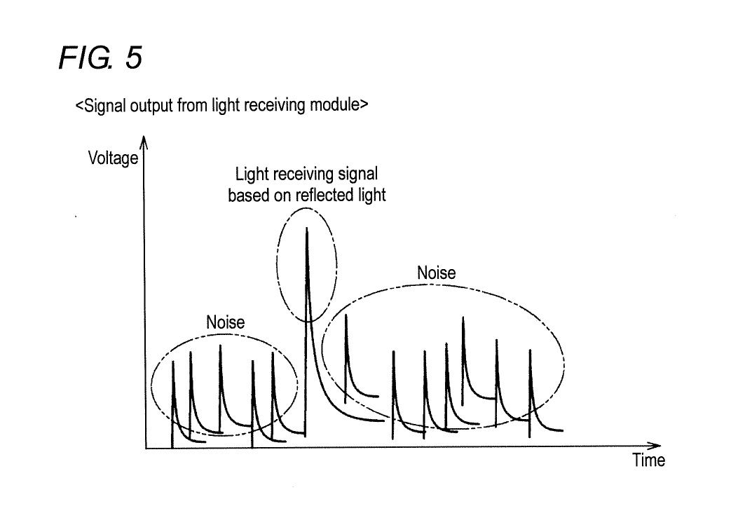

FIG. 5 is a view illustrating an example of the output signals input from the light receiving module 7 to the comparator 8. In FIG. 5, the horizontal axis represents time and the vertical axis represents voltage.

In the SPAD 7s, a rising speed of a signal (current signal) output by the Geiger discharge during the light reception is faster than that of a conventional light receiving element such as a photodiode. Consequently, the output signal (voltage signal) from the light receiving module 7 according to the light receiving state of each SPAD 7s of the SPAD group 7g rises sharply as illustrated in FIG. 5. When the Geiger discharge is stopped due to the quenching resistor Rc, the signal output from the SPAD 7s drops rapidly to a certain extent, and then decreases gently. Consequently, as illustrated in FIG. 5, the signal output from the light receiving module 7 drops rapidly to a certain extent, and then decreases gently.

In this way, the light receiving module 7 in which the plurality of SPADs 7s are used as the light receiving element outputs the voltage pulse having sharp rising and falling edges compared with a light receiving module in which a conventional light receiving element is used.

In the case that the reflected light of the light pulse emitted from the LD 2a by the object 50 is incident on the SPAD group 7g, the number of SPADs 7s on which the photons are incident increases, so that the current output from the SPAD group 7g increases. On the other hand, in the case that the ambient light is incident on the SPAD group 7g, the number of SPADs 7s on which the photons are incident decreases compared with the case that the light reflected by the object 50 is incident, so that the current output from the SPAD group 7g decreases.

Consequently, a level (peak value) of the signal output from the light receiving module 7 based on the light reflected by the object 50 increases as surrounded by an alternate long and short dash line in FIG. 5. On the other hand, the level (peak value) of the signal output from the light receiving module 7 based on the ambient light decreases as surrounded by an alternate long and two short dashes line in FIG. 5.

Because the ambient light is stationary light while the light reflected by the object 50 is temporary light, the photons of the ambient light are always randomly incident on each SPAD 7s of the SPAD array 7a. Consequently, the current signal is always randomly output from each SPAD group 7g according to the reception of the ambient light, and the voltage signal having the small level is always randomly output from the light receiving module 7 based on the ambient light as illustrated in FIG. 5.

Sometimes a dark pulse or an after-pulse is output from each SPAD group 7g due to an ambient temperature or an individual characteristic. The level of the dark pulse or the after-pulse is lower than that of the pulse based on the light reflected by the object 50. For this reason, the voltage signal having the small level is also randomly output from the light receiving module 7 based on the dark pulse or the after-pulse as surrounded by the alternate long and two short dashes line in FIG. 5.

In the signals output from the light receiving module 7, the signal output based on the light reflected by the object 50 is a light receiving signal for measuring the distance to the object 50, and the signal output based on the ambient light, the dark pulse, or the after-pulse is a noise that is not involved in the distance measurement.

The comparator 8 illustrated in FIG. 4 compares the signal (voltage signal) output from the MUX 7c with a predetermined threshold (a threshold Vt in

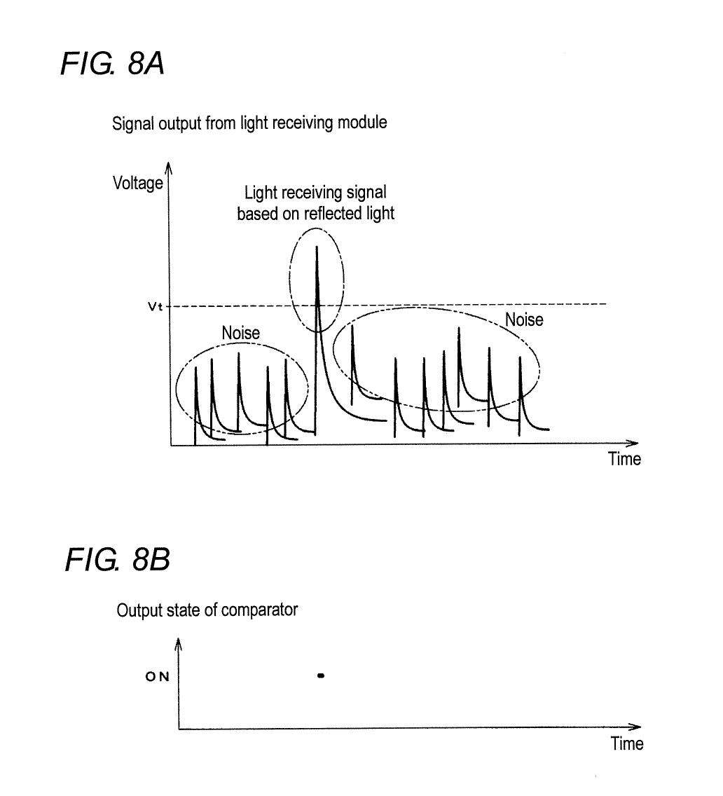

FIG. 8 (to be described later)), and distinguishes whether the output signal is the light receiving signal for the distance measurement or the noise. Specifically, in the case that the output signal of the MUX 7c is larger than the threshold, the comparator 8 outputs a predetermined signal (for example, a high-level signal) to the ADC 9 in order to indicate that the output signal is the light receiving signal for the distance measurement.

In the case that the output signal of the MUX 7c is equal to or less than the threshold, the comparator 8 does not output the predetermined signal to the ADC 9 in order to indicate that the output signal is the noise. At this point, the comparator 8 may output another predetermined signal (for example, a low-level signal) to the ADC 9, or may not output any signal to the ADC 9. The comparator 8 is an example of the “comparison output unit” in one or more embodiments of the disclosure.

The ADC 9 is a 1-bit analog-digital converter with a sampling rate of 10 GSps. The ADC 9 converts an analog signal output from the comparator 8 into a digital signal at high speed, and outputs the digital signal to the controller 1. Specifically, when the predetermined signal is output from the comparator 8, the ADC 9 converts the predetermined signal into a digital signal “1”, and outputs the digital signal “1” to the controller 1. When the predetermined signal is not output from the comparator 8 (when another predetermined signal is output from the comparator 8 or when the output of the comparator 8 is in a no-signal state), the ADC 9 outputs a digital signal “0” to the controller 1.

The distance calculator 1a of the controller 1 detects an irradiation time of the light pulse from the LD 2a. When the digital signal “1” is output from the ADC 9, a reception time of the reflected light of the light pulse from the LD 2a by the object 50 is detected based on the digital signal “1”. The distance to the object 50 is calculated based on the irradiation time of the light pulse and the reception time of the reflected light. In particular, Time of Flight (TOF) of the light pulse emitted from the LD 2a is detected, and the distance to the object 50 is calculated based on the TOF.

The level of the noise (FIG. 5) detected by the light receiving module 7 fluctuates due to a surrounding environment. In order to accurately distinguish whether the signal output from the light receiving module 7 is the light receiving signal for the distance measurement or the noise, it is necessary to appropriately set the threshold used in the comparator 8 in each time. For this reason, the threshold is changed according to the level of the noise output from the light receiving module 7 by the comparator 8, the ADC 9, the maximum value detector 1b of the controller 1, the threshold setting unit 1c, and the DAC 10, as described later.

The DAC 10 is an 8-bit digital-analog converter. The DAC 10 converts the digital signal associated with the threshold input from the controller 1 into the analog signal, and outputs the analog signal to the comparator 8. The comparator 8 changes the threshold based on the analog signal input from the DAC 10.

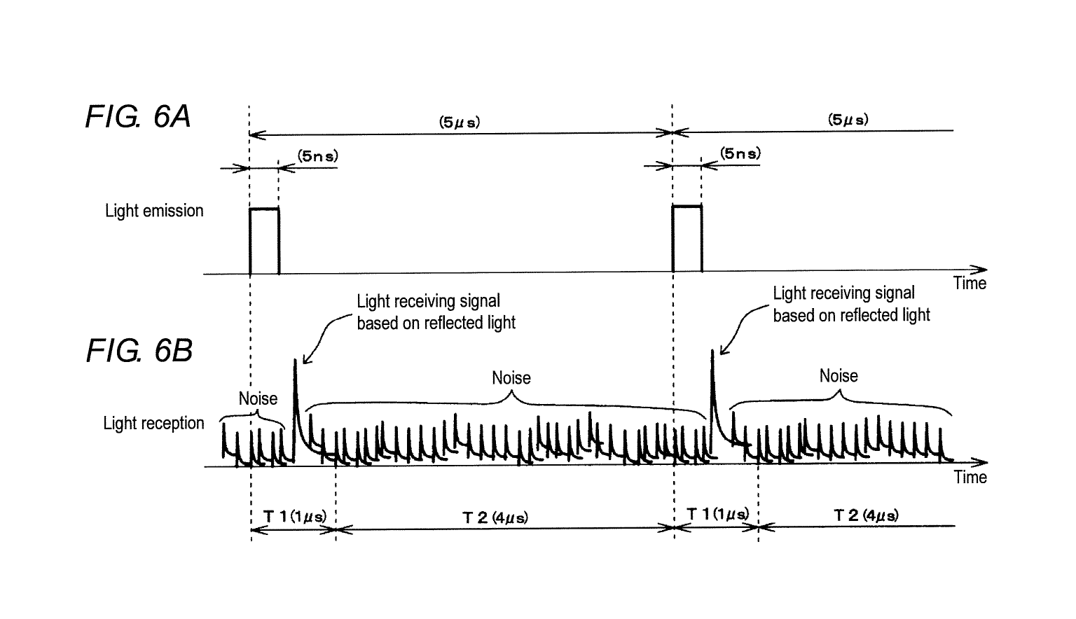

FIGS. 6A and 6B are views illustrating operation timing of the distance measuring apparatus 100. For example, as illustrated in FIG. 6A, the light pulse is emitted from the LD 2a of the light emitting module 2 at every 5 μs (microseconds) with a width of 5 ns (nanoseconds). The operation of the LD 2a is controlled by the controller 1, and the irradiation time of the light pulse from the LD 2a is detected by the distance calculator 1a.

The TOF of the distance calculator 1a takes 1 μs to measure the distance. For this reason, a light receiving period T1 in which the light receiving module 7 receives the light reflected by the object 50 of the light pulse is 1 μs since the irradiation of the light pulse by the LD 2a is started (FIG. 6B). Because the light pulse is not emitted from the LD 2a for the subsequent 4 μs, the subsequent 4 μs are a non-light receiving period T2 in which the light receiving module 7 does not receive the light reflected by the object 50 of the light pulse (FIG. 6B). In the non-light receiving period T2, the ambient light is received by the light receiving module 7, and the noise output from the light receiving module 7 is detected.

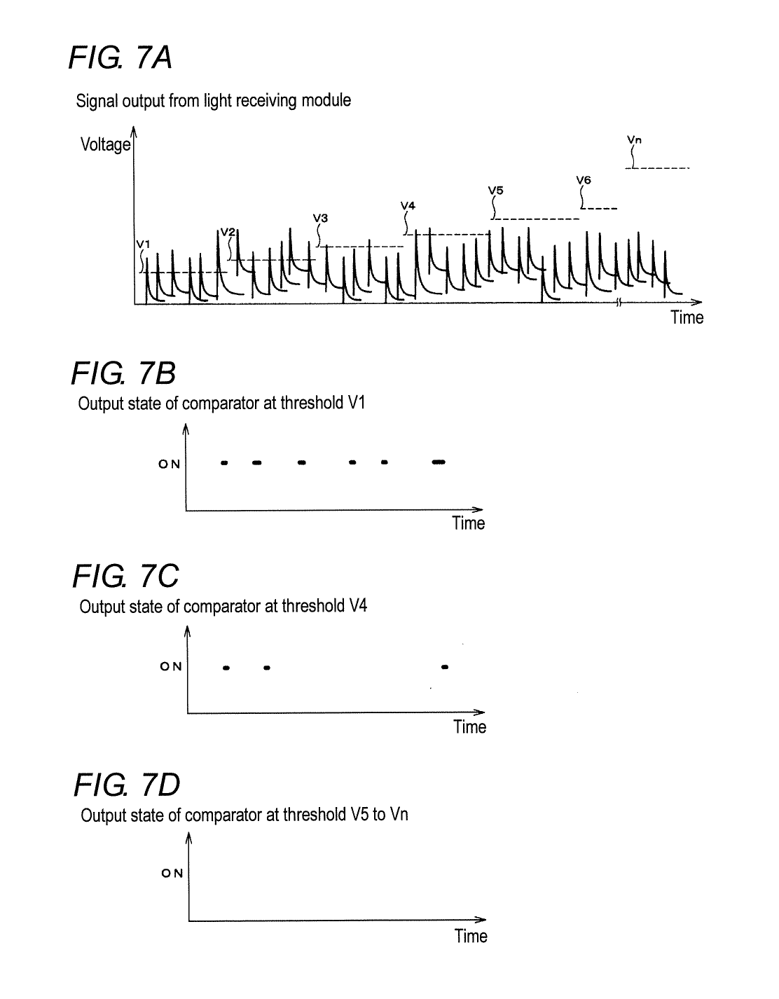

FIGS. 7A to 7D are views illustrating output signals of the light receiving module 7 and the comparator 8 during the noise detection. FIG. 7A illustrates a signal output from the light receiving module 7 in the non-light receiving period T2 of FIG. 6. The output signal in FIG. 7A is the noise based on the ambient light, the dark pulse, or the after-pulse, and the output signal does not include the light receiving signal based on the light reflected by the object 50.

In the non-light receiving period T2, the threshold setting unit 1c of the controller 1 outputs digital information indicating a plurality of tentative thresholds V1 to Vn having different sizes in a stepwise manner to the DAC 10 in ascending order. Every time the information indicating any one of the tentative thresholds V1 to Vn is inputted from the threshold setting unit 1c, the DAC 10 converts the information into the analog signal, and outputs the analog signal to the comparator 8. Every time the signal indicating any one of the tentative thresholds V1 to Vn is input from the DAC 10, the comparator 8 switches the tentative thresholds V1 to Vn to compare each of the tentative thresholds V1 to

Vn to the signal output from the light receiving module 7. That is, as illustrated in FIG. 7A, the tentative threshold compared to the signal output from the light receiving module 7 is changed stepwise from V1→V2→V3→ . . . →Vn.

The comparator 8 outputs a predetermined signal (on signal) when the signal output from the light receiving module 7 is larger than the tentative threshold. FIGS. 7B and 7C representatively illustrate the output states of the comparator 8 when the comparator 8 compares the signal output from the light receiving module 7 to the tentative thresholds V1 and V4. The on signal is output from the comparator 8 while the output signal exceeds the tentative thresholds V1 and V4. FIG. 7D illustrates the output state of the comparator 8 when the comparator 8 compares the signal output from the light receiving module 7 to the tentative thresholds V5 to Vn. The on signal is not output from the comparator 8 because the output signal does not exceed the tentative thresholds V5 to Vn.

The ADC 9 converts the predetermined signal output from the comparator 8 into the digital signal, and outputs the digital signal to the controller 1. The maximum value detector 1b of the controller 1 detects an output frequency of the predetermined signal output from the comparator 8 through the ADC 9 in each of the tentative thresholds V1 to Vn output from the threshold setting unit 1c, and detects the maximum value of the noise based on the output frequency.

Specifically, for example, the maximum value detector 1b detects a value (range), which is greater than or equal to the maximum tentative threshold in the tentative thresholds at which the predetermined signal is output and is less than the minimum tentative threshold in the tentative thresholds at which the predetermined signal is not output, as the maximum value of the noise. A value, which is equal to or greater than the tentative threshold V4 and is less than the tentative threshold V5, is the maximum value of the noise in the example of FIG. 7.

As another example, the maximum tentative threshold in the tentative thresholds at which the predetermined signal is output may be detected as the maximum value of the noise. In this case, in the example of FIG. 7, the tentative threshold V4 is the maximum value of the noise.

For example, in the case that ten values having different sizes are set as tentative thresholds V1 to Vn (n=10), the non-light receiving period T2 of 4 is divided into 10 sections corresponding to each threshold, and one section becomes 400 ns. By converting the signal output from the comparator 8 using the 1-bit ADC 9, pieces of data of at least 400 samples can be observed during the non-light receiving period T2.

As described above, when the maximum value of the noise is detected by the maximum value detector 1b, the threshold setting unit 1c sets a threshold (hereinafter, referred to as a “real threshold”) Vt for the distance measurement based on the maximum value. At this point, for example, the threshold setting unit 1c sets the tentative threshold, which is larger than the maximum value of the noise detected by the maximum value detector 1b by one stage, as the real threshold Vt. In the example of FIG. 7, because the maximum value of the noise is less than the tentative threshold V5, the tentative threshold V5 is set as the real threshold Vt.

As another example, the tentative threshold equivalent to the maximum value of the noise detected by the maximum value detector 1b may be set as the real threshold Vt. Specifically, in the example of FIG. 7, because the maximum value of the noise is equal to or greater than the tentative threshold V4, the tentative threshold V4 may be set as the real threshold Vt. That is, the real threshold Vt may be set larger than or equal to the maximum value of the noise detected by the maximum value detector 1b.

The threshold setting unit 1c outputs digital information indicating the real threshold Vt to the DAC 10. The DAC 10 converts the information indicating the real threshold Vt into the analog signal, and outputs the analog signal to the comparator 8. The comparator 8 changes the threshold to be compared to the signal output from the light receiving module 7 based on the signal input from the DAC 10. Consequently, the comparator 8 compares the signal output from the light receiving module 7 to the real threshold Vt during the light receiving period T1 in which the light receiving module 7 receives the light reflected by the next object 50. That is, every time the light pulse is emitted from the LD 2a, the threshold used in the comparator 8 is changed according to the noise level.

As another example, the threshold used in the comparator 8 may be changed according to the noise level every time the light pulse is emitted from the LD 2a a predetermined number of times.

FIGS. 8A and 8B are views illustrating output signals of the light receiving module 7 and the comparator 8 during the detection of the reflected light. FIG. 8A illustrates the signal output from the light receiving module 7 in the light receiving period T1 of FIG. 6. The output signal includes the noise based on the ambient light and the light receiving signal based on the light reflected from the object 50.

As described above, by setting the real threshold Vt in the previous non-light receiving period T2, the noise does not become larger than the real threshold Vt in the current light receiving period T1, but only the light receiving signal based on the light reflected from the object 50 becomes larger than the real threshold Vt. The comparator 8 outputs the predetermined signal (on signal) as illustrated in FIG. 8B when the signal output from the light receiving module 7 is larger than the real threshold Vt, whereby the predetermined signal certainly becomes the signal based on the light reflected by the object 50.

When the predetermined signal output from the comparator 8 is input to the controller 1 through the ADC 9, the distance calculator 1a detects the reception time of the light reflected from the object 50 based on the input signal. The distance calculator 1a detects the TOF of the light pulse based on the irradiation time of the light pulse from the LD 2a and the reception time of the light reflected from the object 50, and calculates the distance to the object 50 based on the TOF.

According to an illustrative embodiment, because the ambient light is received by the SPAD 7s of the light receiving module 7 during the non-light receiving period T2 in which the light receiving module 7 does not receive the reflected light of the light pulse emitted from the light emitting module 2 by the object 50, the signal output from the light receiving module 7 according to the light receiving state of the SPAD 7s becomes only the noise based on the ambient light or the ambient temperature. Consequently, the maximum value detector 1b detects the maximum value of the noise, and the threshold setting unit 1c sets the real threshold Vt based on the maximum value, so that the real threshold Vt can be set according to the noise level.

Even if the noise is included in the signal output from the light receiving module 7 during the light receiving period T1 in which the light receiving module 7 receives the reflected light of the light pulse emitted from the light emitting module 2 by the object 50, the comparator 8 compares the signal output from the light receiving module 7 to the real threshold Vt, so that the light receiving signal based on the reflected light and the noise can certainly be distinguished from each other. When the signal output from the light receiving module 7 is larger than the real threshold Vt, namely, when the signal output from the light receiving module 7 is the light receiving signal based on the reflected light, because the comparator 8 outputs the predetermined signal, the distance calculator 1a detects the reception time of the reflected light, and the distance to the object 50 can accurately be calculated based on the reception time and the irradiation time of the light pulse from the light emitting module 2. Thus, the distance to the object 50 can accurately be measured even if the noise is included in the signal output from the light receiving module 7.

In an illustrative embodiment, in the non-light receiving period T2 in which the light receiving module 7 does not receive the light reflected by the object 50, the threshold setting unit 1c sets the real threshold Vt to a value larger than the maximum value detected by the maximum value detector 1b. For this reason, in the light receiving period T1 in which the light receiving module 7 receives the reflected light from the object 50 of the light pulse, the comparator 8 can compare the signal output from the light receiving module 7 to the real threshold Vt, and certainly output the predetermined signal corresponding only to the light receiving signal based on the reflected light in the case that the signal output from the light receiving module 7 is greater than the real threshold Vt. The distance calculator 1a can detect the reception time of the reflected light based on the predetermined signal input from the comparator 8 through the ADC 9, and calculate the distance to the object 50 with higher accuracy based on the reception time and the irradiation time of the light pulse emitted from the light emitting module 2.

In an illustrative embodiment, the light receiving module 7 includes the SPAD array 7a in which the plurality of SPAD groups 7g in which the plurality of SPADs 7s are connected in parallel are arrayed and the TIA 7b that converts the current signal output from each SPAD group 7g into the voltage signal. Consequently, the voltage signal output in each SPAD group 7g according to the reception state of each SPAD 7s can be selected by the MUX 7c, and taken into the comparator 8. Then, the comparator 8 can output the predetermined signal based on the comparison between the voltage signal from the light receiving module 7 and the threshold, and input the predetermined signal to the controller 1 through the ADC 9. The rising of the output current signal is faster than that of the other light receiving elements, so that the SPAD 7s can increase the number of outputs of the voltage signal from the light receiving module 7 per unit time to enhance the detection accuracy of the distance to the object 50.

In an illustrative embodiment, in the non-light receiving period T2 in which the light receiving module 7 does not receive the reflected light of the light pulse by the object 50, the comparator 8 sequentially switches the plurality of tentative thresholds having different sizes in a stepwise manner, compares the tentative threshold to the signal output from the light receiving module 7, and outputs the predetermined signal when the output signal is larger than the tentative threshold. The maximum value detector 1b detects the maximum value of the signal output from the light receiving module 7 based on the output frequency of the predetermined signal output from the comparator 8 through the ADC 9 in each tentative threshold. Consequently, the maximum value detector 1b can accurately detect the maximum value of the noise output from the light receiving module 7, and the threshold setting unit 1c can certainly set the threshold corresponding to the noise level.

In an illustrative embodiment, the 1-bit ADC 9 converts the predetermined analog signal sequentially output from the comparator 8 into the predetermined digital signal. Consequently, based on the voltage signal output from the light receiving module 7 in each SPAD group 7g according to the reception state of the SPAD 7s, the signal output from the comparator 8 can be converted into the digital signal at high speed by the ADC 9, and taken into the controller 1. The distance calculator 1a increases the number of samples used to detect the TOF of the light pulse so as to improve the detection accuracy of the TOF, thereby further improving the measurement accuracy of the distance to the object 50.

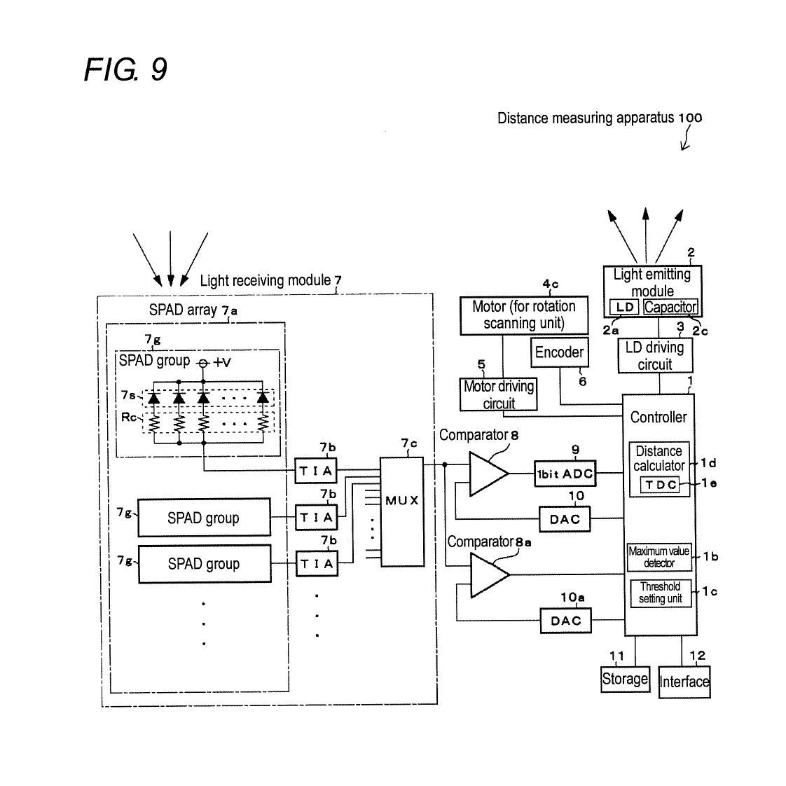

The disclosure can adopt various embodiments except for an illustrative embodiment. For example, in an illustrative embodiment, the maximum value detector 1b and the threshold setting unit 1c set the real threshold Vt based on the predetermined signal input from the comparator 8 to the controller 1 through the 1-bit ADC 9, and the distance calculator 1a calculates the distance to the object 50. However, the disclosure is not limited thereto. For example, as illustrated in FIG. 9, instead of the comparator 8 and the DAC 10 for the threshold setting, a comparator 8a and a DAC 10a may be provided in order to calculate the distance, and the output signal of the comparator 8a may be supplied to a Time to Digital Converter (TDC) 1e provided in the controller 1. The comparator 8a is an example of the “comparison output unit” in one or more embodiments of the disclosure. The TDC 1e is included in the distance calculator 1d.

In FIG. 9, the voltage signal is output from the MUX 7c of the light receiving module 7 to each of the comparators 8, 8a. In the non-light receiving period T2 in which the reflected light of the light pulse by the object 50 is not received, the threshold setting unit 1c sequentially sets the tentative threshold to the comparator 8 through the DAC 10. The comparator 8 compares the signal output from the light receiving module 7 to the tentative threshold, and outputs the predetermined signal based on the comparison result. The comparator 8 inputs the predetermined signal to the controller 1 through the 1-bit ADC 9, the maximum value detector 1b detects the maximum value of the noise based on the input signal, and the threshold setting unit 1c sets the real threshold Vt based on the maximum value. Then, the real threshold Vt is set from the threshold setting unit 1c to the comparator 8a through the DAC 10a.

In the light receiving period T1 in which the reflected light of the light pulse by the object 50 is received, the comparator 8a compares the signal output from the light receiving module 7 to the real threshold Vt. In the case that the signal output from the light receiving module 7 is larger than the real threshold Vt, the comparator 8a outputs the predetermined signal to the TDC 1e.

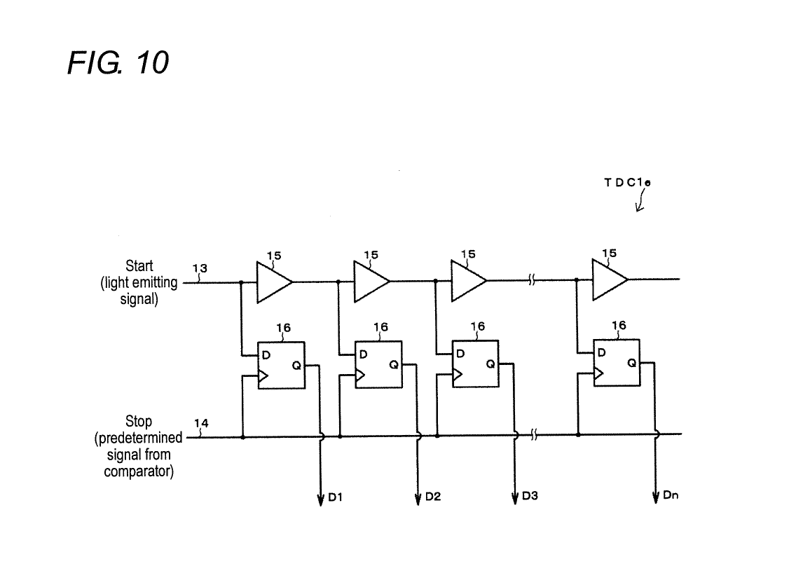

FIG. 10 is a view illustrating the circuit configuration of the TDC 1e. A light emitting signal (an emission command from the controller 1 to the light emitting module 2) is input to a start bus 13 of the TDC 1e in order that the LD 2a emits the light pulse. A plurality of delay buffers 15 are inserted in the start bus 13 to form a delay line. A plurality of D latches 16 are provided so as to correspond to the delay buffers 15, respectively. The light emitting signal is sequentially input to each delay buffer 15 through the start bus 13, and sequentially input from the position in front of each delay buffer 15 to an input terminal D of each D latch 16. The light receiving signal is input to the other input terminal of each D latch 16 through a stop bus 14. Digital output signals D1 to Dn are input from output terminals Q of the D latches 16 to the distance calculator 1d.

Based on the input of the light emitting signal to the start bus 13, the distance calculator 1d detects the irradiation time of the light pulse, and detects the reception time of the reflected light based on the output of each of the output signals D1 to Dn from the D latches 16. The distance calculator 1d calculates the flight time of the light pulse based on the irradiation time of the light pulse and the reception time of the reflected light, and measures the distance to the object 50 based on the flight time. Consequently, the TDC 1e can measure the time by high-speed sampling (for example, 10 GSps).

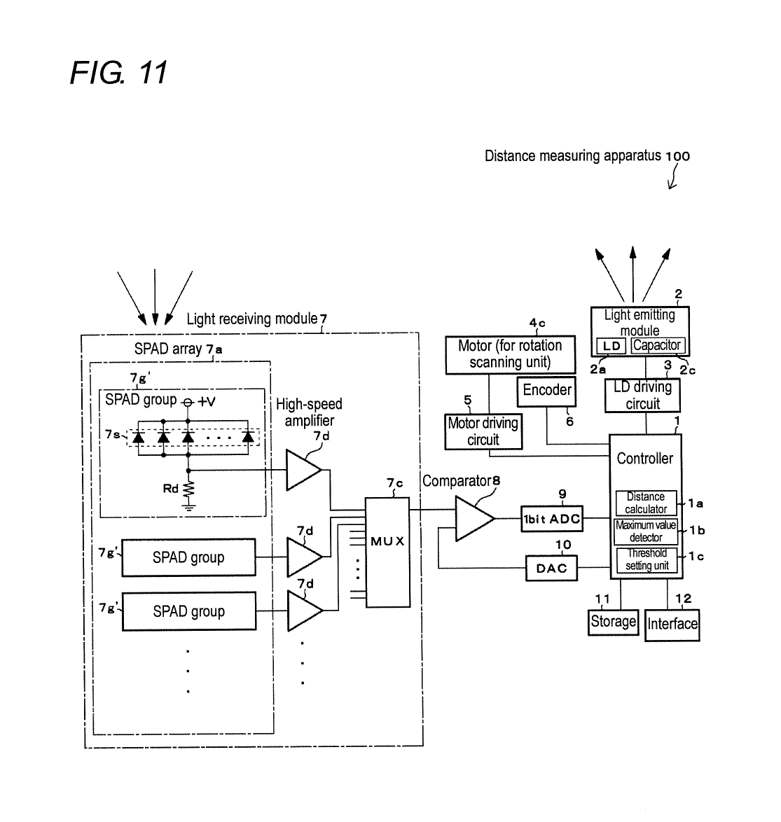

In an illustrative embodiment, as illustrated in FIG. 4, by way of example, the quenching resistor Rc is connected to each SPAD 7s of the SPAD group 7g in a one-to-one manner, and the current output from each SPAD group 7g is converted into the voltage by the TIA 7b. However, the disclosure is not limited thereto. For example, as illustrated in FIG. 11, a common resistor Rd and a high-speed amplifier 7d may be connected to the anode sides of the plurality of SPADs 7s of each SPAD group 7g′. In this case, due to the incidence of the photon on the SPAD 7s, the current flows through the SPAD group 7g′ to generate a voltage drop in the resistor Rd. The high-speed amplifier 7d takes out the voltage drop as the voltage signal, and outputs the voltage signal to the MUX 7c.

In an illustrative embodiment, by way of example, the comparator compares the voltage signal corresponding to the current output from each SPAD group to the threshold. However, the disclosure is not limited thereto. For example, the comparator may compare the current signal corresponding to the current output from each SPAD group to the current threshold to distinguish whether the current signal is the light reflected by the object or the noise.

In an illustrative embodiment, by way of example, the SPAD is used as the light receiving element. However, the disclosure is not limited thereto, but other light receiving elements may be used. Only one element group in which the plurality of light receiving elements are connected in parallel may be provided in the light receiver like the SPAD group. Alternatively, the plurality of light receiving elements may be independently provided in the light receiver without forming the light receiving element group, and the signal corresponding to the light receiving state of each light receiving element may be output from the light receiver. One or a plurality of light emitting elements except for the LD may be used.

In an illustrative embodiment, by way of example, the disclosure is applied to the on-vehicle distance measuring apparatus 100. However, the disclosure can also be applied to a distance measuring apparatus for other purposes.

While the invention has been described with reference to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A distance measuring apparatus comprising:
a light emitter including a light emitting element that emits a light pulse;
a light receiver including a plurality of light receiving elements that receive reflected light of the light pulse by an object;
a comparison output unit that compares an output signal output from the light receiver according to a reception state of the light receiving element to a predetermined threshold and outputs a predetermined signal when the output signal is larger than the threshold;
a distance calculator that detects a reception time of the reflected light by the light receiver when the comparison output unit outputs the predetermined signal, and calculates a distance to the object based on the reception time and an irradiation time of the light pulse from the light emitter;
a maximum value detector that detects a maximum value of the output signal from the light receiver during a non-light receiving period in which the light receiver does not receive the reflected light; and
a threshold setting unit that sets the threshold in the non-light receiving period based on the maximum value detected by the maximum value detector.

2. The distance measuring apparatus according to claim 1, wherein the threshold setting unit sets the threshold to a value equal to or larger than the maximum value detected by the maximum value detector.

3. The distance measuring apparatus according to claim 1,
wherein the light receiving element is constructed with an Avalanche Photo Diode (APD) in a Geiger mode, and
wherein the light receiver includes at least one light receiving element group in which the plurality of light receiving elements are connected in parallel, and outputs a voltage signal corresponding to a current output from the light receiving element group as the output signal.

4. The distance measuring apparatus according to claim 1,
wherein during the non-light receiving period,
the comparison output unit sequentially switches a plurality of tentative thresholds having stepwise different sizes, compares the plurality of tentative thresholds to the output signal output from the light receiver, and outputs the predetermined signal when the output signal is larger than the tentative threshold, and
wherein the maximum value detector detects the maximum value of the output signal output from the light receiver based on an output frequency of the predetermined signal output from the comparison output unit in each tentative threshold.

5. The distance measuring apparatus according to claim 1, further comprising a 1-bit analog-to-digital converter that converts the analog predetermined signal output from the comparison output unit into a digital predetermined signal and outputs the digital predetermined signal to the distance calculator.

6. The distance measuring apparatus according to claim 1, wherein the distance calculator includes a Time to Digital Converter (TDC).
